(19) United States
(12) Patent Application Publication
(10) Pub. No.: US 2020/0192776 A1
(43) Pub. Date: Jun. 18, 2020

(54) SERVER STRUCTURE, A METHOD OF RESOURCE AGGREGATION AND A METHOD FOR OBTAINING SENSOR DATA OF A SERVER

(71) Applicants: INVENTEC (PUDONG) TECHNOLOGY CORPORATION, Shanghai City (CN); INVENTEC CORPORATION, Taipei City (TW)

(72) Inventors: Jia-Ling HU, Shanghai City (CN); Guo-Xin SUN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/246,315

(22) Filed: Jan. 11, 2019

(30) Foreign Application Priority Data
Dec. 13, 2018 (CN) 201811525625.4

(51) Int. Cl. G06F 11/30; G06F 9/50; G06F 9/38; G06F 13/36

(52) U.S. Cl. CPC G06F 11/3031; G06F 11/3006; G06F 13/36; G06F 9/3877; G06F 9/5077

(57) ABSTRACT

This disclosure provides a server structure, a management controller of the mainboard of a mainboard obtains a sensor record from a resource box and saves the sensor record in the server. The mainboard has an external interface, and the management controller of the mainboard of the mainboard externally provides the sensor record of the mainboard and the obtained from the resource box of the resource box management controller of the mainboard through the external interface. This disclosure further provides a method for resource aggregation for the server, which comprises: S1: the management controller of the mainboard of the mainboard loads the sensor record of the resource box to the server; S2: the management controller of the mainboard of the mainboard integrals the sensor record of the resource box and the sensor record of the mainboard into a whole set sensor record.

### CROSS-REFERENCE TO RELATED APPLICATIONS

This non-provisional application claims priority under 35 U.S.C. § 119(a) on Patent Application No(s). 201811525625.4 filed in China on Dec. 13, 2018, the entire contents of which are hereby incorporated by reference.

### BACKGROUND

### 1. Technical Field

The disclosure relates to a computer manufacturing filed, more particularly to a server structure, a method for resource aggregation and a method for obtaining a sensor data of a server.

### 2. Related Art

In the server composed by the mainboard (host) and the GPU (graphic processing unit) resource box, since the mainboard and the GPU resource box have independent BMCs (the board manage controller, or the management controller) respectively, and the firmware performed in the BMCs is different, as a result, the resources of the SDR (the sensor data record, or the sensor record) of the mainboard and the GPU resource box are monitored, managed and saved by the respective BMCs.

Since the mainboard and the GPU resource box is managed separately, it needs two management interface. Hence, parts of the resources for operating and maintaining are wasted, and the entirety of the server management is affected. In addition, from the perspective of the experience from the user, if the user wants to obtain the SDR information of the server, the user needs to access the BMC of the mainboard and the BMC of the GPU resource box respectively in order to obtain the completed SDR information of the server, and then the users further needs to integrate the data by himself. For these reasons, the series of operation steps are not convenient for the user, and the user can not understand the monitored condition of the whole housing of the server directly. Additionally, for the external traces of the server, if the mainboard and the GPU resource box are controlled by independent BMCs respectively, it needs to configure the external traces from the mainboard and the GPU resource box respectively in order to meet the demand for the user searching. Thus, the cost of the hardware is increased, and the management in the later time becomes more difficult.

### SUMMARY

Preferably, the management controller of the mainboard integrates the sensor record of the mainboard and all the sensor records of the resource box into the sensor record of the server, and the management controller of the mainboard supplies the sensor record of the server externally.

Preferably, at least one resource box sends sensor data of the at least one resource box to the management controller of the mainboard thorough an intelligent platform management bus.

Preferably, the at least one resource box comprises a graphic processing unit (GPU).

The method for the resource aggregation comprises the following steps:

step S1, loading at least one sensor record of at least one resource box to a server by a management controller of a mainboard;

step S2, integrating the at least one sensor record of the at least one resource box and a sensor record of the mainboard into a sensor record of the server by the management controller of the mainboard.

Preferably, the management controller of the mainboard performs the step S1 and the step S2 repeatedly and periodically by the management controller of the mainboard, and renewing a server log adapted for user access simultaneously according to the sensor record of the server by the management controller of the mainboard.

Preferably, in the step 1, the management controller of the mainboard obtains the at least one sensor record of the at least one resource box through an intelligent platform management bus.

Preferably, when the server is going through initialization and the numbers of the at least one sensor record and the at least one resource box are plural, the management controller of the mainboard loads the sensor records of the resource boxes one by one according to a previous sensor record.

Preferably, the sensor record comprises the sensor serial number and the sensor data at least. Also, in the step S1, the management controller of the mainboard loads the sensor data to the mainboard from the resource box periodically according to the sensor serial number, and the management controller of the mainboard saves the sensor serial number and the sensor data.

Preferably, when the management controller of the mainboard has included the sensor records of all of the resource boxes, the management controller of the mainboard obtains all of the sensor serial numbers.

Preferably, when the management controller of the mainboard does not have the sensor records of the resource boxes, the management controller of the mainboard obtains the sensor records from the resource boxes to obtain all of the sensor serial numbers.

Preferably, when the management controller of the mainboard has included several of the sensor records of the resource boxes, the management controller of the mainboard obtains other sensor records from other resource boxes of the resource boxes and obtains all the sensor serial numbers.

This disclosure further provides a method for obtaining a sensor data of a server, which comprises the following steps:

P1, receiving a command asked for sending the sensor data by the server;

P2, sending an integrated sensor data of the server to a command sender which sends the command;

wherein, wherein the sensor record of the server is provided by aforementioned method for resource aggregation.

This disclosure further provides a computer storage medium, which saves a computer program, the computer program is able to implement the method for resource aggregation according to claim 5 when the computer program is performed by a management controller of a mainboard of a server. Alternatively, the computer program is able to implement the method for resource aggregation according to claim 13.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a module diagram according to an embodiment of this disclosure;

FIG. 2 is a control block diagram according to an embodiment of this disclosure;

FIG. 3 is a flowchart according to an embodiment of this disclosure.

### DETAILED DESCRIPTION

For making the purposes and the features of this disclosure are more obvious and understandable, the specific implementation of this disclosure is further described hereinbelow with the reference to the accompanying drawings. However, this disclosure may be implemented in different forms and should not be limited to the described embodiments in this disclosure. Also, the embodiments of the present disclosure and the features in the embodiments are allowed for combination or replacement with each other in the condition of the principles are not conflicted with each other. Combining with the following descriptions, the advantages and the features of this disclosure will be clearer.

It should be noted that the drawings are in a very simplified form, and all the drawings are used a non-precise scale. Hence, the drawings are only used for an auxiliary description to the purpose in the embodiments of this disclosure in an easy, clear way.

Also, it needs to declare that, the purpose of numbering the steps is to facilitate the corresponding reference in this disclosure rather than limiting the sequence. For the individual steps which need to be emphasized its order will be described in the specific description in this disclosure.

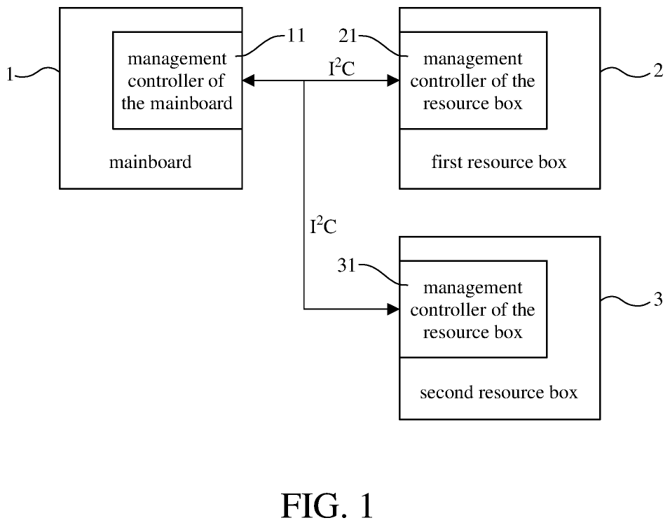

Please refer to FIG. 1. This embodiment provides a server structure which comprises a mainboard 1 including a management controller 11, a first resource box 2 including a management controller 21 and a second resource box 3 including a management controller 31. The management controller 11 of the mainboard obtains a sensor record of the first resource box 2 and a sensor record of the second resource box 3 from the management controller 21 of the first resource box 2 and the management controller 31 of the second resource box 3 respectively, and the management controller 11 of the mainboard saves the sensor record of the first resource box 2 and the sensor record of the second resource box 3 in the server; in other words, the sensor record of the first resource box 2 and the sensor record of the second resource box 3 are saved in the mainboard 1. More specifically, the sensor record of the first resource box 2 and the sensor record of the second resource box 3 may be saved in the management controller 11 of the mainboard. The mainboard 1 is disposed with an external interface, the management controller 11 of the mainboard supplies the sensor record of the mainboard in the management controller 11 of the mainboard 1 externally through the external interface, and the management controller 11 of the mainboard obtains the sensor record of the first resource box 2 and the sensor record of the second resource box 3 from the management controller 21 of the resource box, 31. Between the management controller 11 of the mainboard, the management controller 21 of the resource box and the management controller 31 of the resource box, the control information and control data are sent through the IPMB (intelligent platform management bus) interface in the server. The communicative bus shown in the figure is the I2C (inter-integrated circuit).

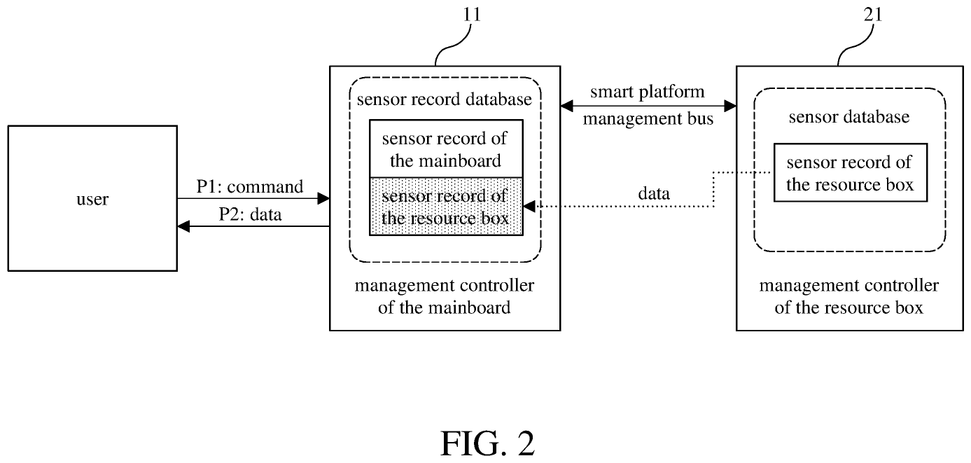

Further, the management controller 11 of the mainboard integrates the sensor record of the mainboard 1 and the sensor records of all of the resource boxes into a sensor record of the server in order to form an integrated sensor record database. When the information is sent externally through the external interface, the mainboard 1 always obtains the sensor data from the sensor record database. As the right part shown in FIG. 2, the management controller 11 of the mainboard and the management controller 21 of the resource box interact with each other through the intelligent platform management bus (IPMB), the sensor record (data) in the management controller 21 of the resource box aggregates into the management controller 11 of the mainboard as the direction shown by the dotted arrow. The sensor record of the resource box and the sensor record of the mainboard are integrated into the sensor record of the server database by the management controller 11 of the mainboard, and the sensor record of the server is saved in the management controller 11 of the mainboard.

Specifically, the first resource box 2 and the second resource box 3 may be the GPU (graphic processing unit) resource box or other resource box.

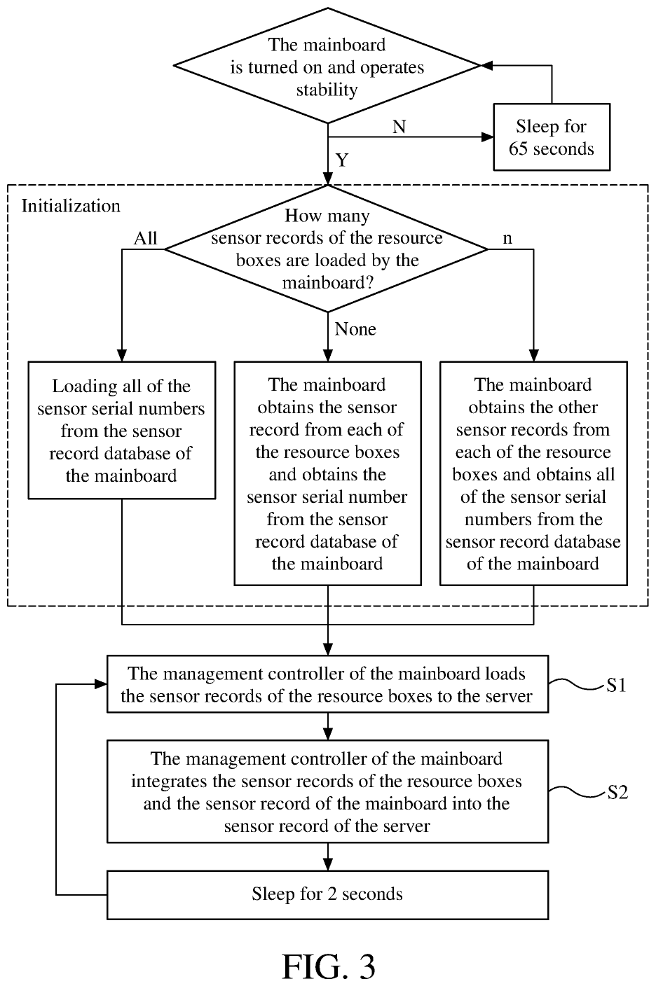

Please refer to FIG. 3. This embodiment further provides a method for the resource aggregation, and the method comprises the following steps:

S1, the management controller of the mainboard loads the sensor records of the resource boxes to the server;

S2, the management controller of the mainboard integrates the sensor records of the resource boxes and the sensor record of the mainboard into the sensor record of the server.

Specifically, during the server operating stability, the management controller of the mainboard performs the step S1 and step S2 in a loop repeatedly in order to implement the function of renewing the sensor record database periodically. Hence, the sensor data between the mainboard and the resource box is able to be simultaneous dynamically. The period is set as 2 seconds in this embodiment. The people with conventional skill in the related field is able to provide other proper period for renewing the sensor record database periodically according to the comprehensive consideration about the amount of the data in the server and the ability of computing.

Specifically, the sensor record at least comprises a sensor serial number and a sensor data. The sensor serial number is corresponding to a respective one of the sensors in the server, so as to serve as the identifier of the sensor. In an embodiment, the sensor serial numbers of the server are saved in the mainboard in advance, and the mainboard determines whether to aggregate all the sensor records according to the sensor serial number saved in the mainboard in advance. When the server goes through initialization, the mainboard compares each of the sensor serial numbers saved in advance with each of the loaded sensor serial numbers renewed currently in the sensor record respectively. As a result, when the sensor serial numbers saved in advance are accordance with the loaded sensor serial numbers renewed currently, it is able to assure that all the sensor records have been loaded.

Further, the function of the mainboard that integrates the sensor record of the mainboard and the sensor record of the resource box into the sensor record of the server (i.e. the sensor record database) and generates the server log corresponding to the sensor record of the server and accessible to the user may be performed during the idle time of the loop, such as after the step S2. Furthermore, the sensor record database is renewed periodically according to the sensor serial number; alternatively, the sensor serial number is able to be regarded as the index number.

Further, as FIG. 3 shows, when the server is initialized, the management controller of the mainboard loads the sensor records of the resource boxes one by one according to the previous sensor record. Since the non-volatile data memory is adapted for saving the sensor record in this embodiment, the sensor data loaded in the last start-up procedure is left in the data memory as the server is restarted every time. For enhancing the continuity of the data monitoring and data recording, when the mainboard is power-on and enters the initialization phase, the mainboard checks the sensor record included in the sensor record database firstly. When all the sensor records of the resource box have been included in the management controller of the mainboard, the management controller of the mainboard obtains all the sensor serial numbers. If the management controller of the mainboard does not have the sensor record of the resource box, the management controller of the mainboard obtains the sensor record from the resource box, and the management controller of the mainboard obtains all the sensor serial numbers. When sensor records from several sensors of the resource box have been included in the management controller of the mainboard, the management controller of the mainboard obtains sensor records from other sensors of the resource box and obtains all the sensor serial numbers.

As the left part shown in FIG. 2, this disclosure further discloses a method for obtaining the server sensor record, and the method comprises the following steps:

P1, the server receives a command asked for sending the sensor record, wherein the command is sent according to the requirement of the user;

P2, the server sends the integrated sensor record of the server to the sender which sends the command, i.e. the user;

wherein, the sensor record of the server is supplied by aforementioned method for the resource aggregation.

Aforementioned server structure is able to use the bus included in the server for aggregating all the sensor records to the mainboard in advance. From the hardware aspect, it does not need to design the traces from the resource box end anymore. When the user needs to search the sensor record, it only needs a management interface and only communicates with the mainboard for searching the mainboard and all the sensor records of the resource box. Hence, it is much more convenient to use, the complexity of the traces is reduced, and the cost of operating and maintaining of the server room is saved efficiently.

Aforementioned method for the resource aggregation is able to aggregate the sensor record to the mainboard periodically from the resource box, when the hardware or firmware of the resource box end changes, the mainboard end is able to obtain related information currently, and the sensor record database is renewed simultaneously. As a result, the robustness and the stability of the server are improved.

Aforementioned method for obtaining the sensor data of the server is able to obtain all the sensor records of the server through a simple command, so the method provides the convenient for the user.

Obviously, people with the conventional skills in the related art is able to make various modifications and variations to this disclosure without departing from the spirit and the scope of this disclosure. Thus, if such modifications and variations of this disclosure fall within the scope of the claims and its equivalent technology of this disclosure, this disclosure is also intended to include these modifications and variations.

What is claimed is:

1. A server structure, which comprises a mainboard having a management controller and at least one resource box, each having a management controller, comprising:
the management controller of the mainboard obtaining at least one sensor record of the at least one resource box from the at least one management controller of the at least one resource box, and the management controller of the mainboard storing the at least one sensor record of the at least one resource box in a server; and
the mainboard having an external interface, with the management controller of the mainboard supplying the sensor record of the mainboard in the management controller of the mainboard externally and obtaining the at least one sensor record of the at least one resource box from the at least one management controller of the at least one resource box through the external interface.

2. The server structure according to claim 1, wherein the management controller of the mainboard integrates the sensor record of the mainboard and the at least one sensor record of all of the at least one resource box into a sensor record of the server and supplies the sensor record of the server externally.

3. The server structure according to claim 1, wherein the at least one resource box sends sensor data of the at least one resource box to the management controller of the mainboard through an intelligent platform management bus.

4. The server structure according to claim 1, wherein the at least one resource box comprises a graphic processing unit.

5. A method for resource aggregation comprising the following steps:
step S1, loading at least one sensor record of at least one resource box to a server by a management controller of a mainboard; and
step S2, integrating the at least one sensor record of the at least one resource box and a sensor record of the mainboard into a sensor record of the server by the management controller of the mainboard.

6. The method for resource aggregation according to claim 5, further comprising: performing the step S1 and the step S2 repeatedly and periodically by the management controller of the mainboard, and renewing a server log adapted for user access simultaneously according to the sensor record of the server by the management controller of the mainboard.

7. The method for resource aggregation according to claim 5, comprising that: in the step S1, the management controller of the mainboard obtains the at least one sensor record of the at least one resource box through an intelligent platform management bus.

8. The method for resource aggregation according to claim 5, comprising that, when the server is going through initialization and the numbers of the at least one sensor record and the at least one resource box are plural, the management controller of the mainboard loads the sensor records of the resource boxes one by one according to a previous sensor record.

9. The method for resource aggregation according to any one of claim 8, comprising that, each of the sensor records comprises a sensor serial number and a sensor data at least.

10. The method for resource aggregation according to any one of claim 9, comprising that, the management controller of the mainboard obtains all of the sensor serial numbers when the management controller of the mainboard has included the sensor records of all of the resource boxes.

11. The method for resource aggregation according to any one of claim 9, comprising that, the management controller of the mainboard obtains the sensor records from the resource boxes to obtain all of the sensor serial numbers when the management controller of the mainboard does not have the sensor records of the resource boxes.

12. The method for resource aggregation according to any one of claim 9, comprising that, when the management controller of the mainboard has included several of the sensor records of the resource boxes, the management controller of the mainboard obtains other sensor records from other resource boxes of the resource boxes and obtains all the sensor serial numbers.

13. A method for obtaining a sensor data of a server, comprising the following steps:
P1, receiving a command asked for sending the sensor data by the server; and
P2, sending an integrated sensor data of the server to a command sender which sends the command;
wherein the sensor record of the server is provided by the method according to claim 5.

14. A computer storage medium which saves a computer program, wherein the computer program is able to implement the method for resource aggregation according to claim 5 when the computer program is performed by a management controller of a mainboard of a server.

15. A computer storage medium which saves a computer program, wherein the computer program is able to implement a method for obtaining a sensor data of the server according to claim 13 when the computer program is performed by a management controller of a mainboard of the server.
